(19) United States
(12) Patent Application Publication
(10) Pub. No.: US 2004/0022355 A1
(43) Pub. Date: Feb. 5, 2004

(54) Methods for identification and verification of materials containing elemental constituents

(76) Inventors: Bruce Kaiser, Draper, UT (US); Robert Shannon, Burbank, WA (US); Vassili Kobyltchak, Richland, WA (US)

Correspondence Address: KENNETH E. HORTON, KIRTON & MCCONKLE, 60 EAST SOUTH TEMPLE, SUITE 1800, SALTLAKE CITY, UT, 84111, US

(21) Appl. No.: 10/306,923

(22) Filed: Nov. 29, 2002

Related U.S. Application Data
(63) Continuation-in-part of application No. 10/006,782, filed on Dec. 5, 2001, now abandoned.

(51) Int. Cl. G01T 1/36

(52) U.S. Cl. 378/49

(57) ABSTRACT

Apparatus and methods in which an elemental constituent, especially low Z elemental constituents, that are intrinsically located—or extrinsically placed—in an object (such as a pharmaceutical) are detected by x-ray fluorescence analysis to identify or verify the object or its point of manufacture. The elemental constituent is manufactured as part of the object or placed into a coating, packaging, label, or otherwise embedded within the object for the purpose of later verifying the presence or absence of these elements by x-ray fluorescence to determine the unique elemental composition of the elemental constituent(s). The apparatus and methods of the invention are simple and easy to use, as well as provide detection by a non line-of-sight method to establish the origin of objects, as well as their point of manufacture, authenticity, verification, or security. The invention is extremely advantageous because it is difficult to replicate, simulate, alter, transpose, or tamper with.

### REFERENCE TO RELATED APPLICATIONS

This application claims priority from U.S. patent application Nos. 10/006,782 and PCT Patent Application No. PCT/US02/22294, the entire disclosures of which are incorporated herein by reference.

### FIELD OF THE INVENTION

The invention generally relates to apparatus and methods for identification and verification. More particularly, the invention relates to apparatus and methods for detecting an elemental constituent intrinsically present—or extrinsically added—in an object by using X-ray fluorescence to identify and verify that object. Even more particularly, the invention related to apparatus and methods for analyzing materials containing low elemental constituent(s), whether intrinsically present or extrinsically added, by using X-ray fluorescence.

### BACKGROUND OF THE INVENTION

There has been significant interest in apparatus and methods for identifying and verifying various articles or products (or objects) such as pharmaceuticals, explosives, ammunition, paint, petroleum products, and low atomic number (low Z) alloys such as those containing aluminum. Known methods used to identify and verify such objects generally involve laboratory chemical analysis with various methods or by adding and detecting materials like code-bearing micro particles, bulk chemical substances, and radioactive substances. Other methods used for identifying and verifying objects include those described in U.S. Pat. Nos. 6,106,021, 6,082,775, 6,030,657, 6,024,200, 6,007,744, 6,005,915, 5,849,590, 5,760,394, 5,677,187, 5,474,937, 5,301,044, 5,208,630, 5,057,268, 4,862,143, 4,485,308, 4,445,225, 4,390,452, 4,363,965, 4,136,778, and 4,045,676, as well as European Patent Application Nos. 0911626 and 0911627, the disclosures of which are incorporated herein by reference.

It is also known to apply materials to objects in order to track, for example, point of origin, authenticity, and their distribution. In one method, inks that are transparent in visible light are sometimes applied to objects and the presence (or absence) of the ink is revealed by ultraviolet or infrared fluorescence. Other methods include implanting microscopic additives that can be detected optically. However, detecting these materials is primarily based on optical or photometric measurements.

Unfortunately, many of the apparatus and methods for measuring the presence and amount of certain elements and/or taggants, as well as identifying and verifying objects in the field using chemical analysis methods are unsatisfactory for several reasons. First, they are often difficult and time-consuming. In many instances, a sample of the object (or the object itself) must be sent to an off-site laboratory for analysis. In other instances, the apparatus are often expensive, large, and difficult to operate. In yet other instances, the taggants are radioactive, causing serious health concerns.

Currently, the pharmaceutical industry is facing a large influx of fake medicine. Diverted and counterfeit drugs are increasingly found in the U.S., as well as throughout the world. Both U.S. and foreign governmental agencies are now looking for new ways to keep the drug supply chain safe. For example, the Food and Drug Administration (FDA) has recently started to look into six counterfeit drug cases, ranging from a psychiatric pill replaced by aspirin to anemia injections that delivered doses 20 times lower than prescribed. Increasingly, sales via the Internet are now a significant part of this problem. No cost effective methodology is currently available that would allow one to readily and quickly verify the authenticity and strength of pharmaceuticals in the field (at the point of use, on the shelf, during shipping), either handheld or otherwise.

### SUMMARY OF THE INVENTION

The invention provides an apparatus and method in which an elemental constituent, especially low Z elemental constituents, that are intrinsically located—or extrinsically placed—in an object (such as a pharmaceutical) are detected by x-ray fluorescence analysis to identify or verify the object or its point of manufacture. The elemental constituent is manufactured as part of the object or placed into a coating, packaging, label, or otherwise embedded within the object for the purpose of later verifying the presence or absence of these elements by x-ray fluorescence to determine the unique elemental composition of the elemental constituent(s). The apparatus and methods of the invention are simple and easy to use, as well as provide detection by a non line-of-sight method to establish the origin of objects, as well as their point of manufacture, authenticity, verification, or security. The invention is extremely advantageous because it is difficult to replicate, simulate, alter, transpose, or tamper with.

### BRIEF DESCRIPTION OF THE DRAWINGS

FIGS. 1, 2a, 2b, 3, 4a, 4b, 5-6, and 7a-b, and 8-11 are views of apparatus and methods for identification and verification according to the invention, in which:

FIG. 1 generally depicts the operation of XRF;

FIGS. 2a and 2b illustrate the operation of XRF at the molecular level;

FIG. 3 shows an exemplary x-ray spectrum, e.g., for paper;

FIG. 4a and 4b depict two aspects of the of the XRF apparatus of the invention;

FIG. 5 illustrates exemplary energy levels of x-rays in an x-ray spectrum;

FIG. 6 shows another aspect of the XRF apparatus of the invention;

FIGS. 7a and 7b show another aspect of the XRF apparatus of the invention;

FIG. 8 shows another aspect of the XRF apparatus of the invention;

FIGS. 9 and 10 show another aspect of the XRF apparatus of the invention; and

FIG. 11 depicts one x-ray spectrum produced in one aspect of the invention.

FIGS. 1, 2a, 2b, 3, 4a, 4b, 5-6, 7a-7b, and 8-11 presented in conjunction with this description are views of only particular—rather than complete—portions of apparatus and methods for identification and verification according to the invention.

### DETAILED DESCRIPTION OF THE INVENTION

The following description provides specific details in order to provide a thorough understanding of the invention. The skilled artisan will understand, however, that the invention can be practiced without employing these specific details. Indeed, the invention can be practiced by modifying the illustrated apparatus and method and can be used in conjunction with apparatus and techniques conventionally used in the industry. For example, the invention is not limited to any specific XRF analysis. Rather, any type of XRF, such as total reflection x-ray fluorescence (TXRF), can be employed in the invention.

The invention uses x-ray fluorescence analysis to detect at least one elemental constituent intrinsically or extrinsically present in the material of an object. An “elemental constituent” includes not only an element in the material or object, but also a taggant. With x-ray fluorescence (XRF) analysis, x-rays produced from electron shifts in the inner shell(s) of atoms of the elemental constituent and, therefore, are not affected by the form (chemical bonding) of the article being analyzed. The x-rays emitted from each element bear a specific and unique spectral signature, allowing one to determine whether that specific elemental constituent is present in the object (e.g., a product or article).

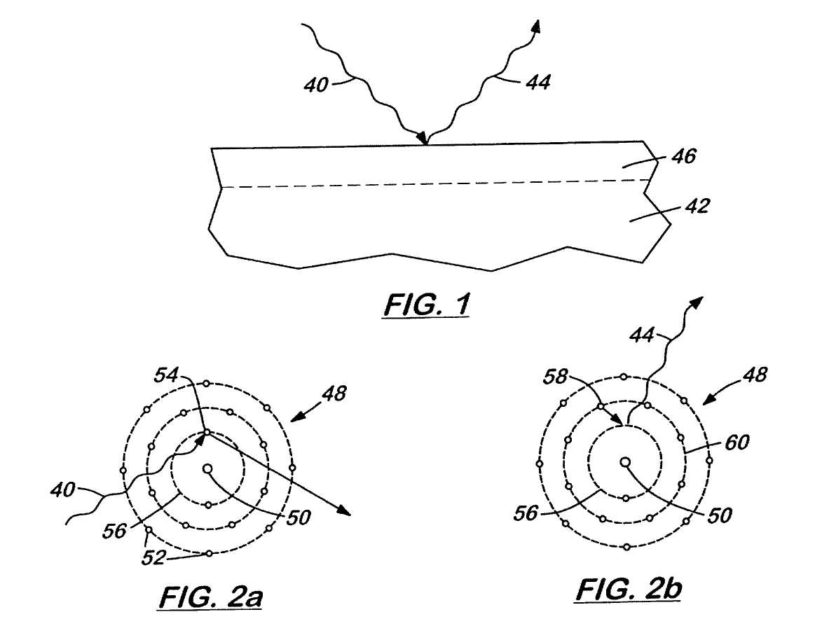

FIGS. 1, 2a, and 2b represent how it is believed XRF generally operates. In FIG. 1, primary gamma rays or x-rays 40 are irradiated on a sample of a target material 46 of article 42. Secondary x-rays 44 are emitted from that sample of target material 46.

In FIGS. 2a and 2b, atom 48 of an elemental constituent located within target material 46 has nucleus 50 surrounded by electrons 52 at discrete energy bands around the nucleus 50 (called electron shells). Each electron has a binding energy level equal to the amount of energy required to remove that electron from its corresponding shell. The innermost shell is the K shell, and has the highest binding energy levels associated with it. Electron 54 is located within K shell 56.

Primary x-ray or gamma ray photon 40 impacting atom 48 has a given energy. If that energy is greater than the binding energy level of K shell 56, the energy of x-ray photon 40 is absorbed by atom 48, and one of the electrons in K shell 56 (i.e., electron 54) is ejected. With a vacancy now in K shell 56 left by electron 54, atom 48 is energetic and unstable. To become more stable, that vacancy in K shell 56 can be—and usually is—filled by an electron located in a shell with a lower binding energy level, such as L-shell electron 58 in L shell 60. As L-shell electron 58 fills the vacancy in K shell 56, atom 48 emits a secondary x-ray photon 44. The energy levels (or corresponding wavelengths) of such secondary x-ray photons are uniquely characteristic to each element or elemental elemental constituent, allowing the presence or absence of any specific elemental constituent to be determined.

The elemental constituent can be intrinsically or extrinsically present in the object to be detected (the “target object”). When the elemental constituent is intrinsically present, it is a component (either as an element, compound, impurity, or other type of composition) in at least one portion of that target object. When the elemental constituent is extrinsically present, it can be added, incorporated, or inserted into the target object as described below.

The elemental constituent employed in the invention can be any suitable elemental constituent known in the art. See, for example, U.S. Pat. Nos. 5,474,937, 5,760,394, and 6,025,200, the disclosures of which are incorporated herein by reference. Suitable elemental constituents include any element that is capable of being detected via XRF. The types of elements that can be used are theoretically any of those listed in the periodic table, but the lower energy emitted by electrons in the lower atomic-number elements could be a limiting factor in one aspect of the invention. Such lower energies can be re-absorbed much easier into its own material matrix or into the ambient atmosphere (e.g, air). Further, different isotopes of an element, as well as elements that “excite” only under certain conditions could be employed as the elemental constituent(s) in the invention.

Examples of elemental constituents that could be used in the invention include any element with an atomic number ranging from 6 to 94. In one aspect of the invention, the elemental constituent that can be used in the invention include any element with an atomic number ranging from 6 to 17. In another aspect of the invention, the elemental constituents include the elements O, Mg, S, F, and Cl. While materials containing these elements typically can be analyzed under laboratory conditions, it has been quite difficult to analyze them under practical conditions in the field, especially using portable apparatus.

The type of elemental constituent depends, among other things, on the target object in which it is located. The material of the target object can interfere with the XRF detection because, as described below, backscattering and peaks emitted by the composition of the target object during XRF analysis can interfere with the elemental constituent peaks. For example, if paper (as the target object) contained an As elemental constituent and trace amounts of Pb existed in the paper, the K-level electrons of As and L-level electrons of Pb could give confusing readings during XRF detection.

In one aspect of the invention, the type of elemental constituent should be selected based on the ability of the elemental constituent and/or the substance in which it is located (i.e., a coating) to attach or bond to the target object. In many instances, the target object will be used, handled, and/or washed extensively. If the elemental constituent (or the substance in which is located) is removed from the target object under such conditions, tagging the target object is of little value. For example, if a film or coating (e.g., ink) containing a elemental constituent is applied to a target object (e.g., paper), the elemental constituent and coating should be selected so that they will not be removed by the conditions to which the target object is periodically subjected (e.g., extensive contact with hands). Preferably, the coating and/or the elemental constituent is selected in this aspect of the invention so that it chemically attaches or bonds to the target object, like paint attaches and bonds with a wall.

In another aspect of the invention, the type of elemental constituent can be selected based on the ability of the elemental constituent and/or the substance in which it is located, such as a coating, to be removed from the target object. In many instances, the purpose for which the target object is tagged will be temporary. After this purpose is completed, the elemental constituent is no longer needed and can optionally be removed. For example, if an identifying film or coating containing a elemental constituent is applied to a target object, once that object has been identified, the identifying film of coating may no longer be needed and can be removed by suitable means. Preferably, the coating and/or the elemental constituent is selected in this aspect of the invention so that it is removable by mechanical or chemical means.

The amount and concentration of the elemental constituent in the target object can also vary depending on the number of elements used and energy needed. The amount of elemental constituent employed in the invention is determined by the minimum amount needed for XRF detection. Additional amounts of elemental constituent can be used as described below. The concentration of the elemental constituent is at least about 1 part per million (ppm), and can range from about 1-100 ppm. Larger elemental constituent amounts can be used, but for economic reasons, a small amount is sufficient. Even lower elemental constituent concentrations can be used (i.e, less than 1 ppm) as improved XRF devices and techniques become available.

The form of the elemental constituent in the target object can also vary. The form can be any compound (i.e., salt) or molecule—either small or large—containing the element that is added by itself or with other components. Indeed, the elemental constituent can be combined with various components and/or additives to make a mixture and/or solution. These other components or additives can be selected for various purposes, e.g., to modify the XRF properties, to modify the ability to be inserted into the target object, to stabilize the mixture or solution, or other purpose known in the chemical arts.

In one aspect of the invention, the at least one elemental constituent is a combination or plurality of elemental constituents. A plurality of elemental constituents could include more than one elemental constituent of the same type, e.g., the same element or compound. A combination of elemental constituents could also be more than one type of elemental constituent, e.g., a different element or compound in different media. For example, a elemental constituent can be dispersed in ink that has been placed on paper that also contains the same or different elemental constituent. The plurality of elemental constituents could also include a combination of at least one intrinsic and at least one extrinsic elemental constituent.

In one aspect of the invention, the at least one elemental constituent incorporated in the target material can provide a distinctive code. Such a code could be based on the number and types of elemental constituents present or absent, an abundance ratio (i.e., concentrations) of the same or different elemental constituents, the location of the elemental constituents within the object (i.e., a barcode made of a series of elemental constituents with a space, where the space could be part of the code), the presence of multiple types or forms of a single elemental constituent, or a combination thereof.

As one example of such a code, the invention can include a system in which the concentration of one elemental constituent in a target object is controlled to provide a distinctive code. For example, for tagging ten commercially prepared batches of carpeting, the elemental constituent yttrium oxide can be used. Ten unique codes could then be created for these ten batches by preparing samples of the target object containing various concentrations (i.e., 10 ppm, 20 ppm, . . . 100 ppm) of that elemental constituent.

The number of unique codes available with the use of just a single elemental constituent depends on the precision with which that concentration can be controlled and measured in the sample. For example, if techniques allow concentrations in about 10 ppm increments, 10 unique codes (i.e., 10 ppm, 20 ppm, . . . 100 ppm) can readily be constructed from a single elemental constituent for that concentration range. Additional codes could be created for larger concentration ranges, e.g., 100 codes of a concentration ranging from 10 ppm to 1000 ppm in 10 ppm increments. With the advent of superior concentration and detection techniques (e.g, for smaller increments), more codes may be constructed.

Further, the number of unique codes can be increased by adding additional types and concentrations of the same or different elemental constituents. A significant increase in the number of possible codes can be achieved by using more than one elemental constituent in creating the code. For example, the code can be expanded by adding another elemental constituent with its own specific concentrations. The number of codes can be further expanded by adding a third elemental constituent with its own specific concentrations. Additional elemental constituents could be used to provide even more codes. This coding system depends on the concentration increments of each of the elemental constituents.

The number of codes available in the coding system could also be increased by varying the location of the elemental constituent(s) within the object to be detected. For example, the detected material could be divided into any number of portions (i.e., quadrants) with certain elemental constituents (or codes) being placed in certain of those portions, and optionally not in others, to signify additional information during the XRF analysis.

When elemental constituents include elements or compounds that may be found in the target object or in the environment to which that object may be exposed, elemental constituent contamination may occur and possibly render the elemental constituent code difficult to read. For example, if a elemental constituent comprising titanium oxide is located in carpet as the target object, it is possible that additional amounts of the elemental constituent(s) could be present in the carpet as a result of environmental contamination, an internal chemical reaction, or other contamination. If this contamination occurs, there will be a change in the concentration of that elemental constituent in the target object. Subsequent measurement of this elemental constituent could yield a value corresponding to an incorrect code.

In such an instance, it is difficult to determine what amount of the elemental constituent present in the target object is “contamination” as opposed to elemental constituent present before contamination. This problem can be solved in target objects for which contamination might be suspected by using a backup (i.e., duplicate or otherwise) or secondary system, such as a backup or secondary elemental constituent(s), backup or secondary code, or backup or secondary location. See, for example, the description in U.S. Pat. No. 5,760,394, the disclosure of which is incorporated herein by reference. If desired, more than one such backup or secondary system can be used. The backup or secondary system can also be used for other purposes, e.g., to verify the original coding system.

Any suitable target object can be employed in the invention. Suitable target objects include those which intrinsically contain the desired elemental constituent(s) or in which the desired elemental constituent(s) can be incorporated. Because XRF detection measures changes in the inner shell(s) of the elemental constituent, it will not be significantly modified by chemical reactions that normally occur in the outer shells. Thus, it is possible to tag chemicals and have the elemental constituent code be carried in any object manufactured with those chemicals. Target objects should be comprised of a material in which XRF detection is easy, e.g., little chance of background contamination, elemental constituent deterioration, elemental constituent destruction, contamination, or other deteriorating condition.

Examples of suitable target objects include any manufactured goods or trade goods. Examples of manufactured goods and trade goods are disclosed in U.S. patent application Ser. No. 10/006,782, the entire disclosure of which is incorporated herein by reference. In one aspect of the invention, the suitable target object is one containing primarily low Z elements, such as a food additive. In another aspect of the invention, the target object is a pharmaceutical product.

Examples of suitable target objects also include those that will be subsequently changed. For example, a target object that is suspected might be destroyed could be tagged with elements known to be present in the residue from the destruction. Since the elemental constituent is not usually changed by the chemical process in destruction, a connection between the target object and its residue could be established after destruction.

The target objects containing the at least one elemental constituent can be used for a wide number of applications. For example, tagging paints would allow any article coated with that paint to be identified. In another example, tagging paper and ink used in the paper (or applied to the paper) can be used to establish the authenticity of documents and currency. In yet another example, many manufactured items prone to counterfeiting or theft could benefit from tagging. Tagged threads in clothing could be used to encode information about the date, time, and place of manufacture. Tagging the bulk materials used in the manufacture of such items as compact discs, computer disks, video tapes, audio tapes, electronic circuits, and other items would be useful in tracing and prosecuting theft and counterfeiting cases involving these items.

In the invention, the at least one elemental constituent can be incorporated into the target object in any suitable form. Suitable forms include those that place that elemental constituent in the target object with little to no damage (either chemical or physical) to that object. See, for example, the description in U.S. Pat. Nos. 5,208,630, 5,760,394, and 6,030,657, the disclosures of which are incorporated herein by reference. Other suitable forms include using materials containing the elemental constituent such as particulates like microparticles; solvents; coatings and films; adhesives; sprays; or a hybrid or combination of these methods. In any of these forms, the at least one elemental constituent can be incorporated by itself or with another agent.

The at least one elemental constituent can be incorporated in the target object using any suitable technique. Many existing tagging techniques involve the use of microparticles containing the elements, or compounds or compositions of the elements, comprising the at least one elemental constituent. Additionally, particles can be manufactured wherein smaller particles, or compounds or compositions of the elements, containing the elemental constituent. Such particles could be made of: magnetic or fluorescent materials to facilitate collection; refractory materials to enhance particle survival in an explosion; or chemically inert materials to enhance particle survival in a chemical reaction. Indeed, such particles could be made of non-durable, soluble, or reactive materials to enhance elemental constituent dispersal in a fluid, aerosol, or powder system.

When the target object is a liquid article like paints or inks, or adhesives, or has a liquid component, the at least one elemental constituent can be incorporated as an element or compound in solution with the liquid. Thus, the at least one elemental constituent can be incorporated in elemental or compound form either in solution or suspension in the target object. The at least one elemental constituent could also be dissolved or suspended in a solvent used in making the target object so that when that solvent evaporates, the residue left behind would contain the at least one elemental constituent.

The elemental constituent can be inserted into the target object of an article either during or after the article (or a part thereof) has been manufactured. The elemental constituent can be manufactured as a component of the article or as part of a component of the article. During manufacture, the at least one elemental constituent can also be incorporated into another material which comprises part of the target object. Indeed, the at least one elemental constituent could also be an element or compound of the target object itself. The elemental constituent can be incorporated into any location (including surfaces) of the article. Two (and three) dimensional shapes and patterns of the at least one elemental constituent can be constructed using any desired combination of types and numbers of elemental constituents.

The at least one elemental constituent could also be incorporated after manufacture of the target object. The at least one elemental constituent could be incorporated into the already formed target object as a dopant. Additionally, the elemental constituent can be implanted into the object or deposited as a coating or film on the object. As a coating or film, the at least one elemental constituent could be physically or chemically deposited by itself. The at least one elemental constituent could also be incorporated as one ingredient (or contaminant) of another material (such as a mixture or solution) which forms a coating or film. In this aspect of the invention, the at least one elemental constituent can be incorporated as an element or compound in solution (or suspension) with a liquid which is applied, such as by spraying, to the object. For example, the at least one elemental constituent could be dissolved or suspended in a solvent so that when that solvent evaporates after being applied to the object, the residue left behind would contain the at least one elemental constituent.

As apparent from the description above, the invention has the ability to easily tag small batches of target objects with a code unique to that batch. This can be done manually or in an automated system where each batch (or select batches) of the target object receives a different code. For example, 1000 (or 100) compact discs could be manufacture and each could be tagged with a code of a number from 1 to 1000 (or 1 to 100). Economic and processing considerations, however, might limit the minimum size of each batch and the number of batches that could be tagged.

After the elemental constituent(s) is extrinsically or intrinsically present in the target object(s), the elemental constituent(s) is detected to identify or verify the target material using XRF analysis as illustrated in FIG. 1. Primary x-rays 40 are used to excite a sample of the target material 46, and the secondary x-rays 44 that are emitted by the sample are detected and analyzed.

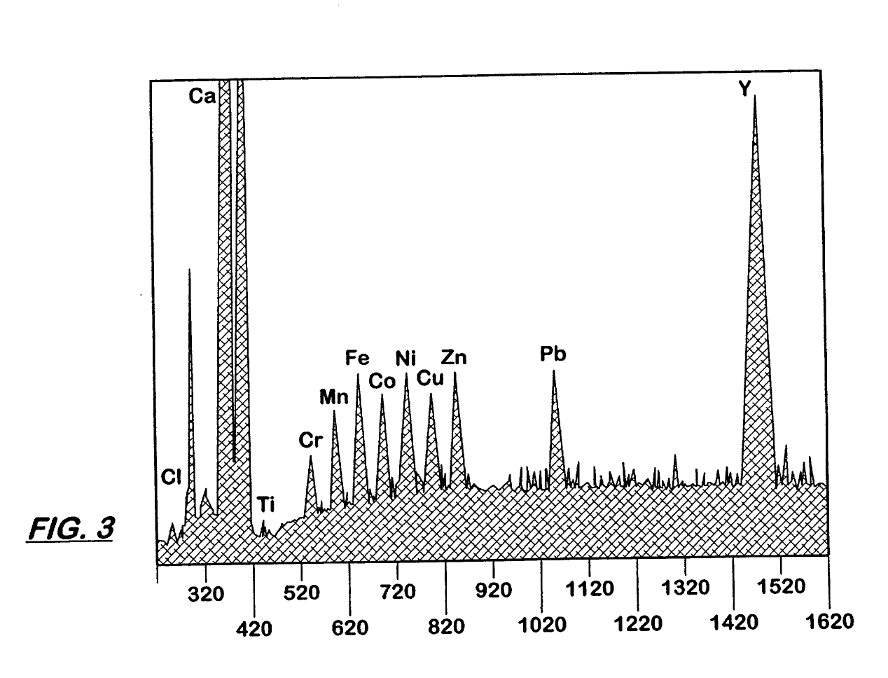

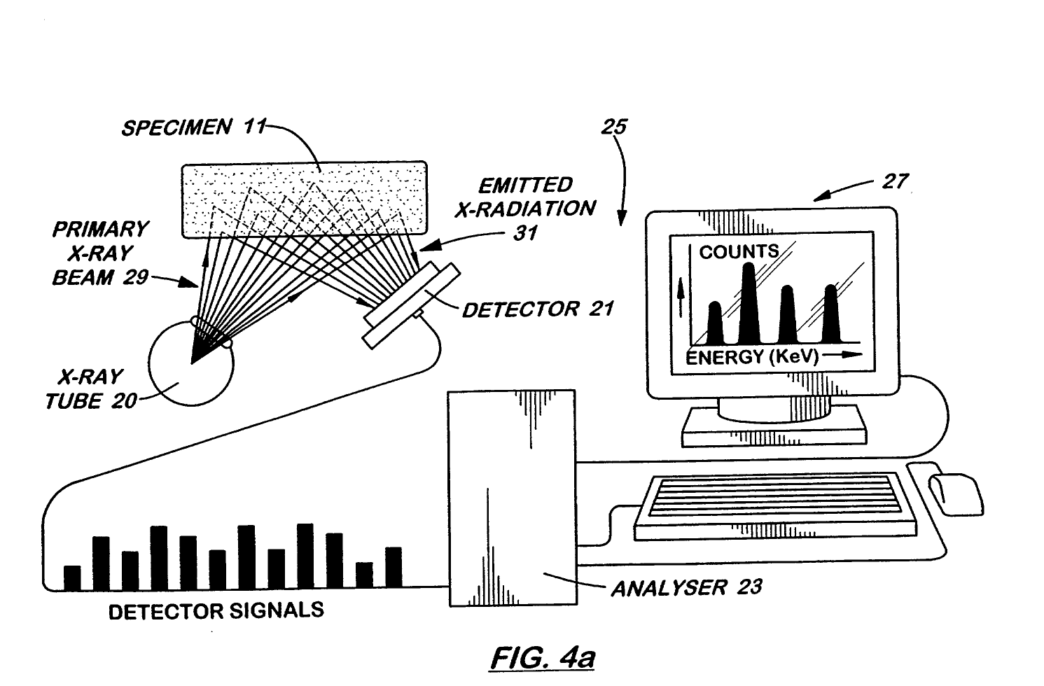

As shown in FIG. 3, the x-rays which are detected have various energies, e.g., there is a broad band of scattered x-rays with energies less than and greater than those of the exciting atom. FIG. 3 illustrates this spectrum for paper as the target object. Within this broad band, there are peaks due to the excitation of the elemental constituent(s) in the sample. The ratio of the intensity of the radiation in any peak to the intensity of the background at the same energy (known as the peak-to-background ratio) is a measure of the concentration of the element, which has characteristic X-rays at the energy of that peak, e.g., the elemental constituent(s).

In one aspect of the detection method of the invention, at least one target object believing to contain known concentrations of the elemental constituent(s) of interest is selected. The XRF analysis is performed on that target object (or a sample thereof) using a detection device or apparatus containing an x-ray radiation source (“source”), x-ray radiation detector (“detector”), support means, analyzer means, and calibration means.

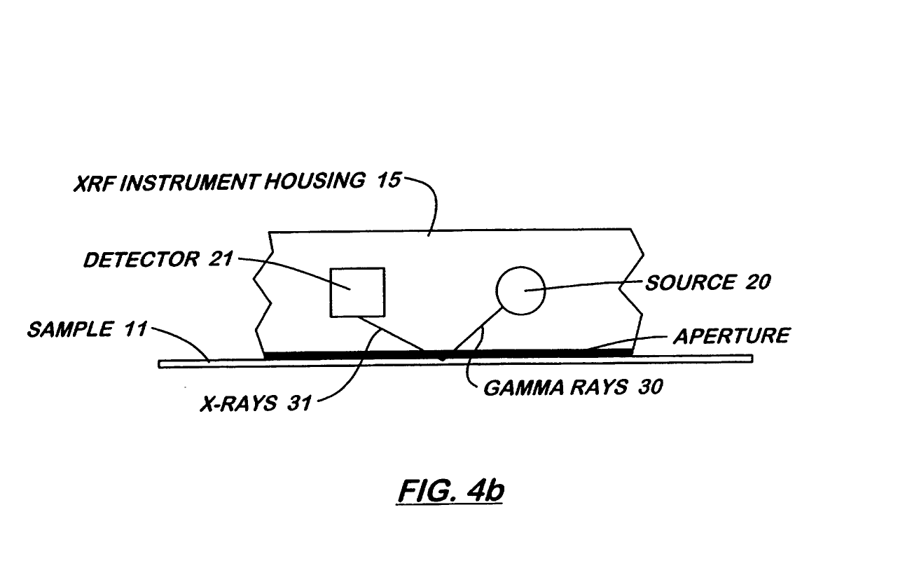

One aspect of the detection device of the invention is illustrated in FIG. 4a. In this Figure, the detection apparatus 25 has an ordinary x-ray fluorescence spectrometer capable of detecting elements present in a coating, package or material. X-rays 29 from a source (e.g., either x-ray tube or radioactive isotope) 20 impinges on a sample 11 which absorbs the radiation and emits x-rays 31 to an x-ray detector 21 and analyzer 23 capable of energy or wavelength discrimination. This is accomplished by using a commercially available x-ray spectrometer such as an Edax DX-95 or a MAP-4 portable analyzer, commercially available from Edax Inc., Mahwah, N.J. Part of analyzer 23 includes a computerized system 27.

Another aspect of the detection apparatus of the invention is illustrated in FIG. 4b. In this Figure, the detection apparatus 25 has an instrument housing 15 containing the various components. Gamma rays or x-rays 30 from a source (e.g., either x-ray tube or radioactive isotope) 20 are optionally focused by aperture 10 to impinge on a sample 11. Sample 11 contains the at least one elemental constituent(s) which absorbs the radiation and emits x-rays 31 to an x-ray detector 21. Optionally, analyzing means can be incorporated within housing 15.

The invention, however, is not limited to the detection apparatus depicted in FIGS. 4a and 4b. Any suitable source, or plurality of sources, known in the art can be used as the source in the detection device of the present. See, for example, U.S. Pat. Nos. 4,862,143, 4,045,676, and 6,005,915, the disclosures of which are incorporated herein by reference. During the XRF detection process, the source bombards the elemental constituent(s) with a high-energy beam. The beam may be an electron beam or electromagnetic radiation such as X-rays or gamma rays. The source, therefore, may be any material that emits such high-energy beams. Typically, these have been x-ray emitting devices such as x-ray tubes or radioactive sources.

To target, the beam can be focused and directed properly by any suitable means such as an orifice or an aperture. The configuration (size, length, diameter . . . ) of the beam should be controlled, as known in the art, to obtain the desired XRF detection. The power (or energy level) of the source should also be controlled, as known in the art, to obtain the desired XRF detection.

The source(s) can be shielded and emit radiation in a space limited by the shape of the shield. Thus, the presence, configuration, and the material used for shielding the source should be controlled for consistent XRF detection. Any suitable material and configuration for that shield known in the art can be employed in the invention. Preferably, any high-density materials used as the material for the shield, e.g., tungsten or brass.

Any suitable detector, or plurality of detectors, known in the art can be used as the detector in the detection device of the invention. See, for example, U.S. Pat. Nos. 4,862,143, 4,045,676, and 6,005,915, the disclosures of which are incorporated herein by reference. Any type of material capable of detecting the photons omitted by the elemental constituent(s) may be used. Silicon and CZT (cadmium-zinc-telluride) detectors have been conventionally used, but others such as proportional counters, germanium detectors, or mercuric iodide crystals can be used.

Several aspects of the detector should be controlled to obtain the desired XRF detection. First, the geometry between the detector and the target material should be controlled. The XRF detection also depend on the presence, configuration, and material—such as beryllium—used as a window to allow x-rays photons to strike the detector. The age of the detector, voltage, humidity, variations in exposure, and temperature can also impact the XRF detection and, therefore, these conditions should be controlled.

The analyzer means sorts the radiation detected by the detector into one or more energy bands and measures its intensity. Thus, any analyzer means performing this function could be used in the invention. The analyzer means can be a multi-channel analyzer for measurements of the detected radiation in the characteristic band and any other bands necessary to compute the value of the characteristic radiation as distinct from the scattered or background radiation. See, for example, U.S. Pat. Nos. 4,862,143, 4,045,676, and 6,005,915, the disclosures of which are incorporated herein by reference.

The XRF also depends on the resolution of the x-rays. Background and other noise must be filtered from the x-rays for proper measurement, e.g., the signals must be separated into the proper number of channels and excess noise removed. The resolution can be improved by cooling the detector using a thermoelectric cooler or liquid nitrogen and/or by filtering.

The support means supports the source and detector in predetermined positions relatively to a sample of the target material to be irradiated. Thus, any support means performing this function could be used in the invention. In one example, the support means comprises two housings, where the source and detector are mounted in a first housing which is connected by a flexible cable to a second housing in which the analyzer means is positioned as illustrated in FIG. 4a. If desired, the first housing may then be adapted to be hand-held. In another example, the source and detector as well as the other components of the detection device are mounted in a single housing as illustrated in FIG. 4b.

The calibration means are used to calibrate the detection apparatus, thus insuring accuracy of the XRF analysis. In this calibration, the various parameters that could be modified and effect the measurement are isolated and calibrated. For example, the geometrical conditions or arrangements can be isolated and calibrated. In another example, the material matrix are isolated and calibrated. Preferably, internal (in situ) calibration during detection is employed as the calibration means in the invention. Components, such as tungsten shielding, are already present to internally calibrate during the XRF analysis. Other methods, such as fluorescence peak or Compton backscattering, could be used for internal calibration in the invention.

Analyzer means, which includes a computerized system 27, is coupled to, receives, and processes the output signals produced by detector 21. The energy range of interest, which includes the energy levels of the secondary x-ray photons 44 emitted by the elemental constituent(s), is divided into several energy subranges. Computerized system 27 maintains counts of the number of X-ray photons detected within each subrange using specific software programs, such as those to analyze the detection and x-ray interaction and to analyze backscatter data. After the desired exposure time, computerized system 27 with display menus stops receiving and processing output signals and produces a graph of the counts associated with each sub range.

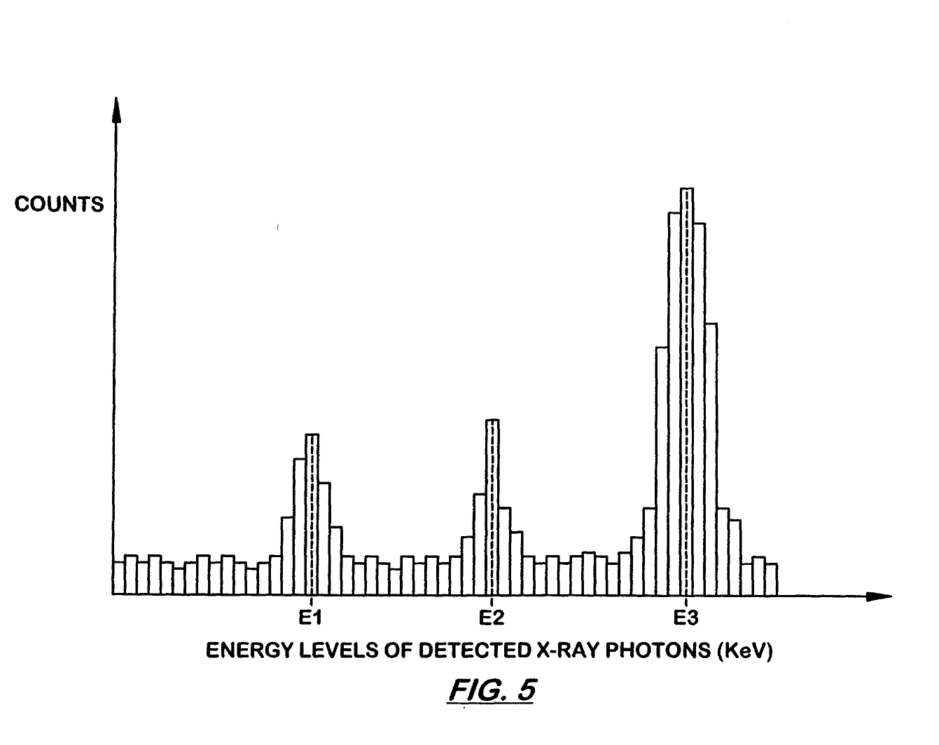

FIG. 5 is a representative graph of the counts associated with each sub range. This graph is essentially a histogram representing the frequency distribution of the energy levels E1, E2, and E3 of the detected x-ray photons. Peaks in the frequency distribution (i.e., relatively high numbers of counts) occur at energy levels of scattered primary x-ray photons as well as the secondary x-ray photons from the elemental constituent(s). A primary x-ray photon incident upon a target material may be absorbed or scattered. The desired secondary x-ray photons are emitted only when the primary x-ray photons are absorbed. The scattered primary x-ray photons reaching the detector of the system create an unwanted background intensity level. Accordingly, the sensitivity of XRF analysis is dependent on the background intensity level, and the sensitivity of XRF detection may be improved by reducing the amount of scattered primary x-ray photons reaching the detector. The peak occurring at energy levels of scattered primary x-ray photons is basically ignored, while the other peaks—those occurring at E1, E2, and E3—are used to identify the at least one elemental constituent(s) present in the target object.

One other parameter that can be controlled during the process of XRF detection is the methods used to interpret and analyze the x-rays. This parameter depends, in large part, on the algorithms and software used along with the apparatus described herein. Thus, methods can be adopted to employ software and algorithms that will consistently perform the XRF detection.

The above parameters of the apparatus can be controlled and varied to obtain accurate measurements. In one aspect of the intention, these parameters could be varied and controlled to another provide a distinct code. For example, using a specific source and a specific detector with a specific measuring geometry and a specific algorithm could provide one distinct code. Changing the source, detector, geometry, or algorithm could provide a whole new set of distinct codes.

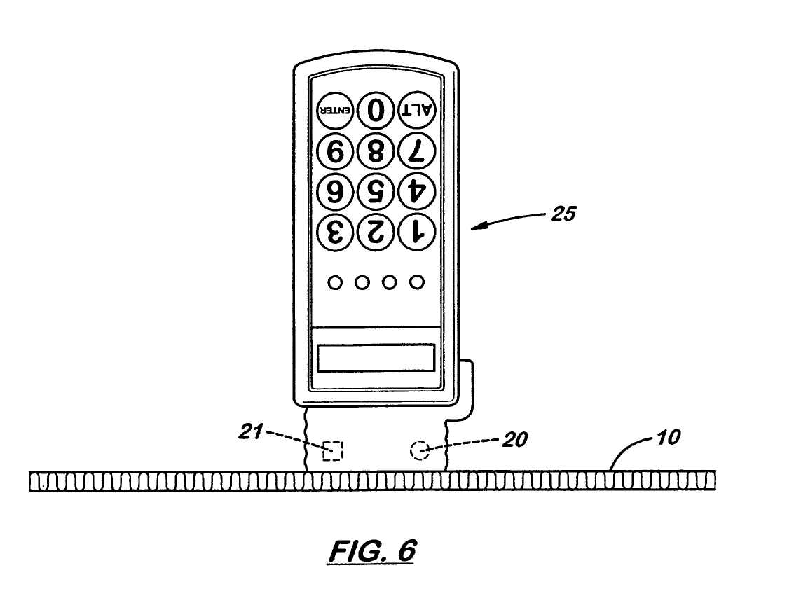

FIG. 6 illustrates another apparatus and detection method according to the invention. In this Figure, detection apparatus 25 is capable of detecting the elemental constituent(s) present in target material 10, such as a pharmaceutical product. Detection apparatus 25 is a portable device that can be small enough to be hand-held. Detection apparatus 25 contains all the components discussed above (i.e., source, detector, analyzer means, and calibration means) in a single housing, thus allowing the portability and smaller size.

In one aspect of the invention, the apparatus and method used identify an object or article once it has been tagged. The ability to invisibly tag an article and read the tag, especially through a non line-of-sight method, provides an invaluable asset in any industry that authenticates, verifies, tracks, labels, or distributes goods of any kind. Indeed, having an invisible elemental constituent(s) could further prevent copying and counterfeiting of goods. In another aspect of the invention, the apparatus and method of the invention could be used for these same purposes, but for those products that have the desired elemental constituent(s) already located therein. Thus, the invention could analyze liquid flows for contaminant particles or pinpoint via 3-D analysis the exact location of a contaminant(s) in an article.

In one aspect of the invention, the methods and apparatus described above can be modified to specifically detect low atomic number (“low Z”) elemental constituents. These elemental constituents are those elements in the lower part of the Periodic Table. In one aspect of the invention, the elemental constituent(s) that can be used in the invention include any element with an atomic number ranging from 6 to 17. In another aspect of the invention, the elemental constituent(s) that can be used in the invention include the elements O, Mg, S, F, and Cl.

The detection of these low Z elements, especially in the field, can be accomplished by a portable XRF apparatus comprising three components. The first component permits the XRF device to operate in an environment other than air. As described above, XRF analysis and XRF apparatus can be limited in terms of the type of elements that can be used as the elemental constituent(s). While XRF can theoretically analyze any element listed in the periodic table, the lower energy emitted by electrons in the lower atomic-number elements can be re-absorbed into the ambient atmosphere (e.g., air). Thus, the ability for XRF to analyze such elements is not extremely efficient. By not operating under air, these lower energies are not re-absorbed into air and this problem can be reduced.

In one aspect of the invention, the first component permits the XRF device to operate under vacuum conditions. To perform XRF under a non-air atmosphere conditions, the apparatus described above is modified so that detection is carried out in a vacuum. Any such modification achieving this function can be employed in the invention, including the modifications described below.

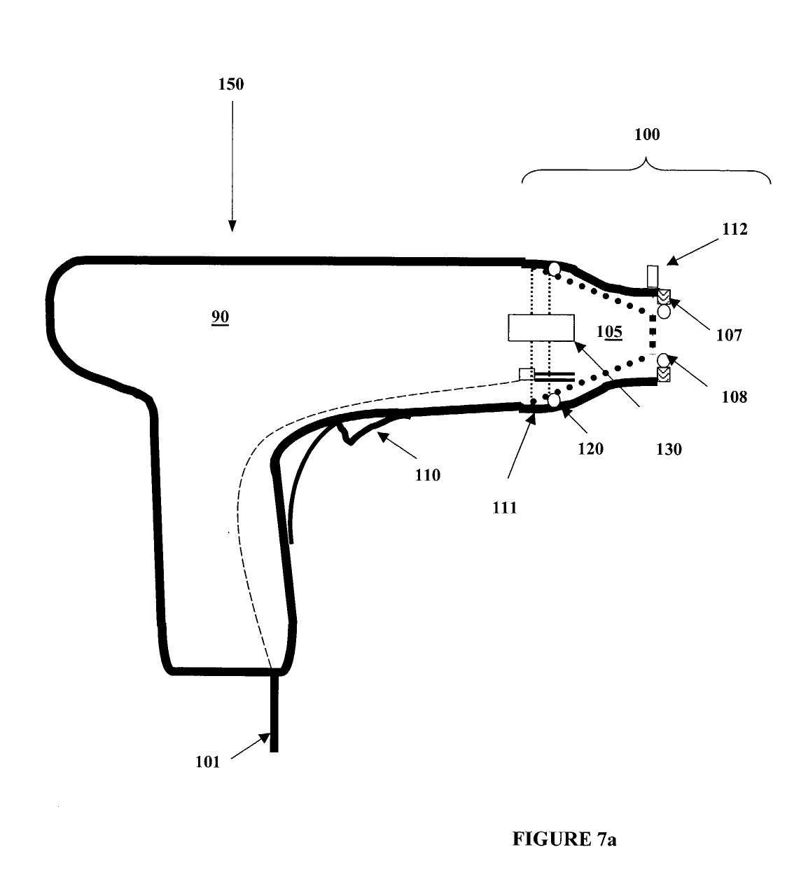

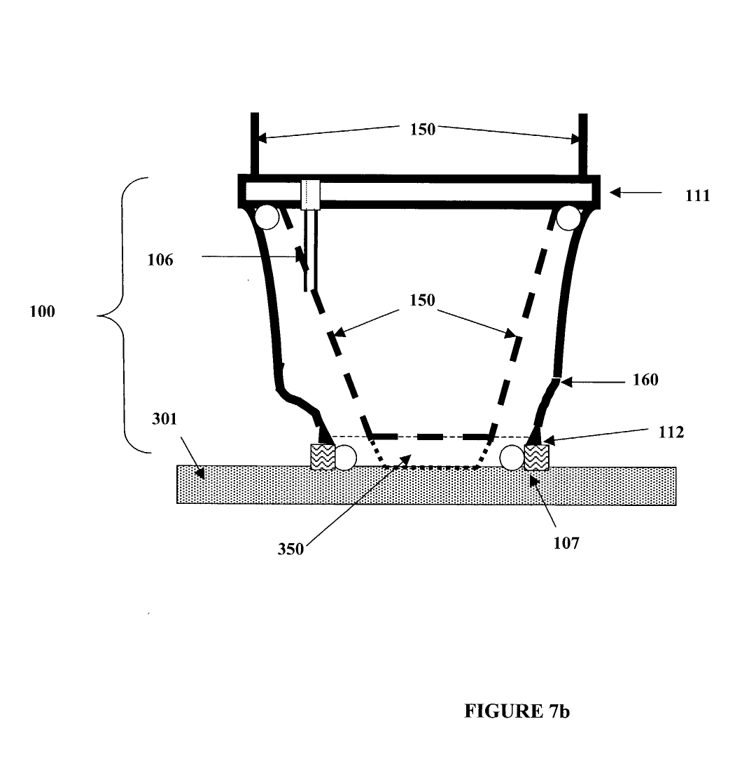

In one aspect of the invention, a “vacuum” XRF (VXRF) apparatus used in the invention is created by modifying a hand-held XRF device (such as alluded to in FIG. 6 and as described in U.S. Pat. No. D460,370, the entire disclosure of which is incorporated herein by reference) with an attachment that creates a vacuum atmosphere. As depicted in FIG. 7a and FIG. 7b, a hand-held XRF device 150 is fitted with a vacuum attachment 100. The vacuum attachment 100 creates vacuum conditions for device 150 in the front end where detection of the elemental constituent(s) occurs.

The vacuum attachment (VA) 100 contains all the necessary components to create a vacuum on the end of device 150. In the aspect of the invention illustrated in FIG. 7a, the vacuum attachment 100 contains a vacuum line 101, vacuum chamber 105, vacuum port 106, seal flange 107, and seal 108. All of these components are combined to create the vacuum conditions at the end of device 150. Other (or alternative) components that are necessary to create and maintain the vacuum can be used in the invention as known in the art.

The vacuum attachment 100 contains a quick disconnect 111 removable front end with an aperture sized to the desired exposure area to be detected. The VA 100 also contains a shutter device 112 that is used to isolate the vacuum chamber 105 when the vacuum conditions are cycled on and off. The VA 100 also contains seals 120 where the VA 100 attaches to the device 150, as well as latches 130 for securely attaching the VA 100 to device 150. Other (or alternative) components that are necessary to aid operation of the vacuum can be used in the invention as known in the art.

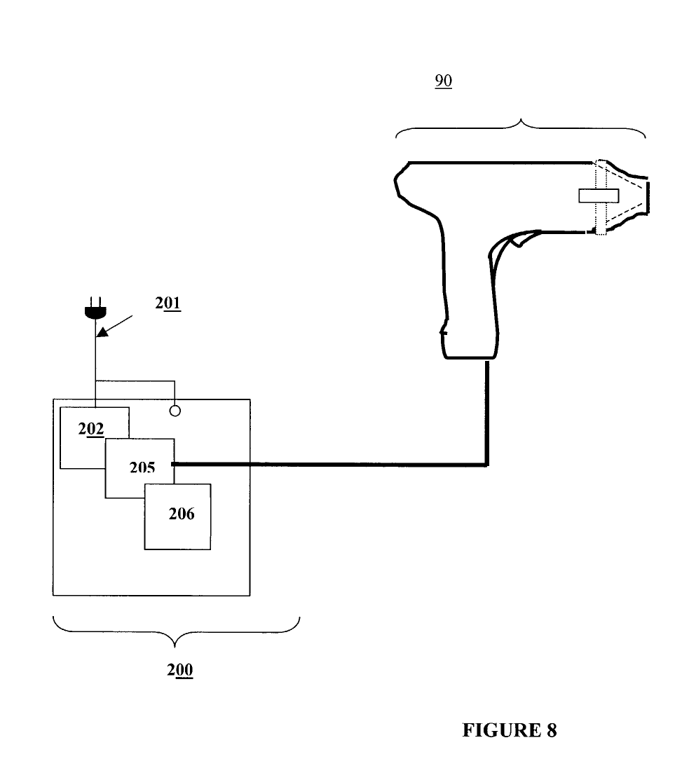

The VXRF device 90 also contains components that are used to create and control the vacuum. As depicted in FIG. 8, VRXF 90 comprises a controller 200 that is connected to a standard 110 volt outlet 201. The controller 200 contains a grounded power supply 202, a vacuum pump 205, and a timer 206 that sequences the operation of the pump 205. Other (or alternative) components that are necessary to create and control the vacuum can be used in the invention as known in the art such as battery operated vacuum systems which are commercially available

The VA 100 in combination with the device 150 operates in the following manner. As shown in FIG. 7b, VA 100 on the device 150 is originally in a position that is not depressed. The VA 100 can then be depressed into position 350 to contact a substrate 301 and to engage the seal mechanism 107 to form an airtight compartment 105. After depressing the device to the surface of the substrate 301 using flexible member 160, a trigger 110 is depressed to activate a timer 206 that controls the air evacuation process. The vacuum pump 205 then draws the ambient air out of the chamber 105 through the vacuum port 106, leaving a clear path of access for the device 150 to contact the surface of substrate 301. After creating the vacuum, the XRF 150 remains pressed to contact the surface in position 350 for the amount of time needed for the XRF analysis. After finishing the XRF analysis, the vacuum pump 205 is turned off and the VA attachment is then slowly removed.

The VXRF apparatus 90 can create any desired vacuum condition that is necessary to analyze the elemental constituent(s) being analyzed. In one aspect of the invention, the VXRF apparatus 90 can create a vacuum ranging from about 1 to about 10⁻⁷ torr. In another aspect of the invention, VXRF apparatus 90 can create a vacuum ranging from about 1 to about 10⁻² torr. Under these conditions, the VXRF apparatus 90 can more efficiently detect and analyze elemental constituent(s) containing elements with atomic numbers of 9 to 17.

In another aspect of the invention, the non-air atmosphere is not a vacuum. In this aspect of the invention, the first component permits the XRF device to operate in an atmosphere containing primarily light gases, e.g., gases with an atomic number less than 5. Examples of such gases include H and He, and mixtures thereof. In one aspect of the invention, substantially pure He is used as the gas for this atmosphere. In one aspect of the invention (where the light gaseous mixture contains both H and He), the amount of He in the light gas atmosphere can range from about 60 to about 80% by volume.

Using a light gas atmosphere instead of a vacuum provides two advantages. First, as described more in detail below, the apparatus is easier to make and use. Second, it provides a better analysis of liquid target objects where evaporation of the object might be a concern in a vacuum.

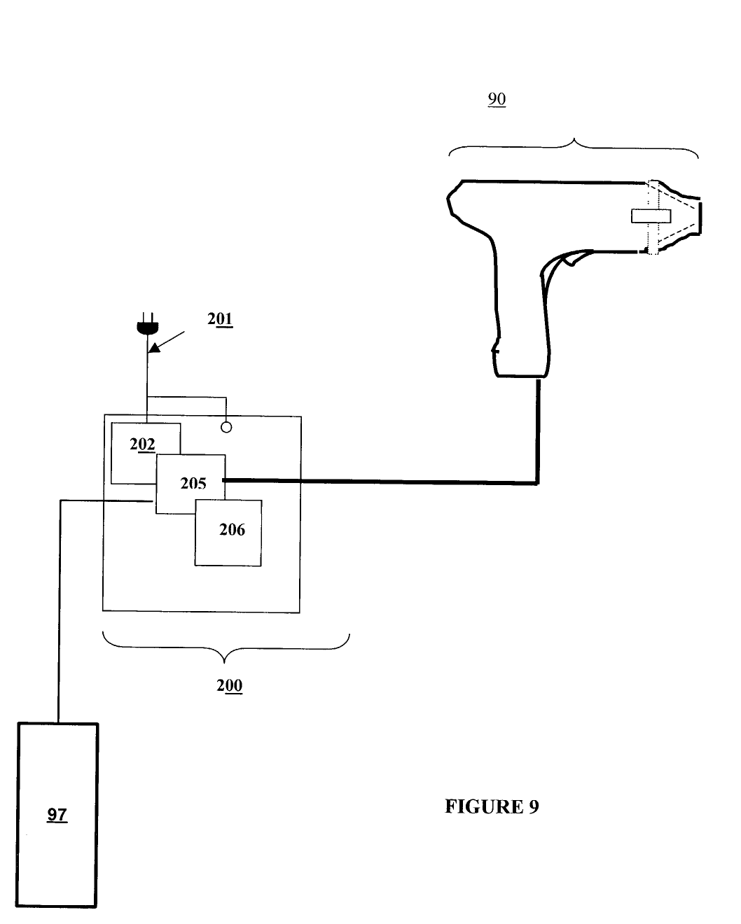

To create the light gaseous atmosphere, an apparatus similar to that described in FIGS. 7a, 7b, and 8 above can be employed. In this aspect of the invention and as shown in FIG. 9, once the air is evacuated, a light gas mixture is then inserted where the air was removed. This result can be achieved by adding reservoir 97 that contains the desired gaseous mixture. The reservoir 97 is connected to vacuum pump 205. Once the air is removed by the vacuum pump, the pump is reversed and then used to pump the light gaseous mixture back into chamber 105. The XRF operation is then carried out to analyze the sample containing the elemental constituent(s).

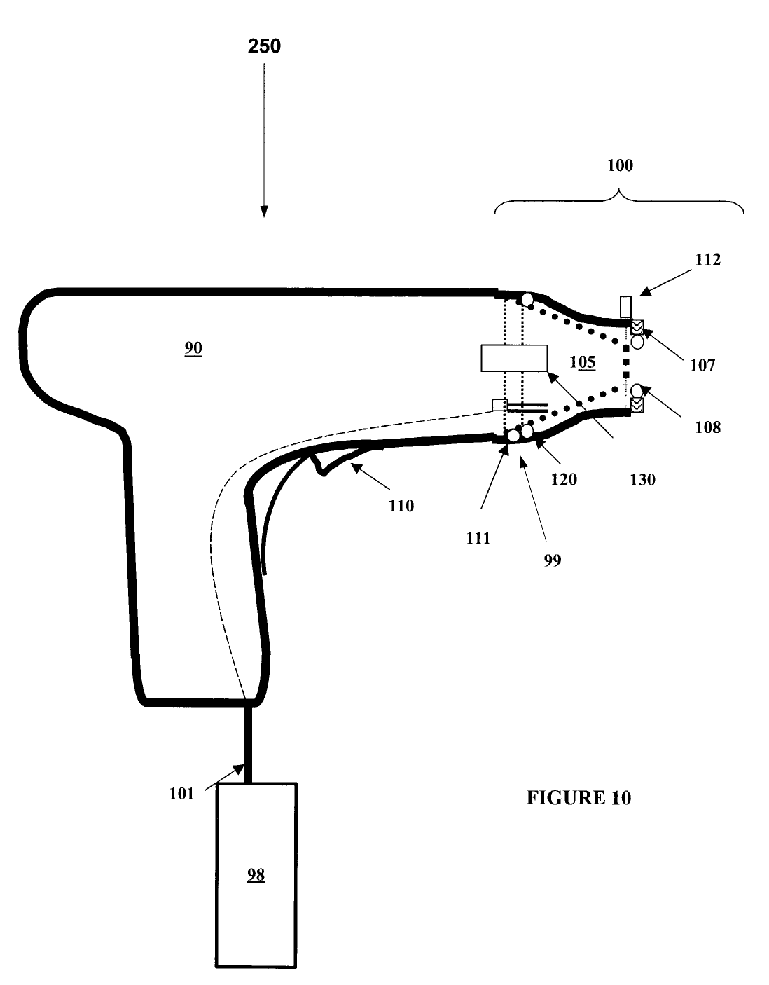

In another aspect of the invention, the light gaseous atmosphere can be created without the need to first create a vacuum. This aspect of the invention is illustrated in FIG. 10. Here, device 250 is similar to the VXRF apparatus described above, with the exception that controller 200 is replaced with a pressurized reservoir 98 containing the light gas mixture. When actuating mechanism (trigger 110) is depressed, the light gas mixture enters the chamber 105 through the line 101 and forces the air out of the chamber.

If necessary, a one-way check valve 99 can be strategically placed to aid the procedure of removing the air while keeping the light gas mixture in the chamber. To remove the air, this valve 99 is placed in the lowest vertical position of the attachment 100. The light gas mixture is lighter than air and when it enters the chamber 100, it is forced to the top of the chamber. As the chamber 105 fills with the light gas mixture, the air is forced out through the valve 99. To verify that that the air has been removed, device 250 can be actuated to analyze whether any components of air (i.e., O and especially Ar) remain in the chamber 105.

The second component that is helpful to detect low Z elements is a combination of parts in an XRF device that more easily provides and detects energies emitted by such elements. Any part or combination of parts that achieves this function can be used in the invention. In one aspect of the invention, an x-ray tube (rather than a radioactive source) in combination with a specially designed window is used for this function.

Conventional radioactive sources generally only provide x-rays within a narrow x-ray spectrum that depends on the specific type of source used. Most currently available radioactive sources are not able to provide sufficient x-rays with energies that match the binding energies of the low Z elements. An x-ray tube overcomes this problem by emitting a wider range of energies and is able to increase the numbers of atoms excited in the low Z elements.

Most detectors of XRF devices have a window through which the x-rays pass. Most windows have a thickness that does not allow sufficient amounts of x-rays emitted by low Z elements to pass since they have a much lower energy. The windows used in the invention have been specially designed to decrease the thickness of the window, while maintaining the structural integrity. The decreased thickness allows a greater amount of x-rays with lower energies to pass through the window and be detected.

The third component that is helpful to detect low Z elements is low noise electronics in the XRF device. When a XRF device is used to analyze a sample, there is often a lot of “noise” that is produced. This noise is generated by at least 3 sources: first, incoming x-rays; second, noise in the detector; and third, noise generated in signal processing. This noise can be misleading and make proper resolution of the x-rays in the spectrum difficult. The third component of the invention helps reduce this noise and increase the resolution in the x-ray spectrum.

Any element or combination of elements that achieves this function can be used as the third component in the invention. In one aspect of the invention, the third component comprises a thermoelectric cooled detector. In another aspect of the invention, the third component comprises a pre-amplifier.

In yet another aspect of the invention, the third component primarily reduces the third type of noise. The third component can comprises hardware that combines both analog and digital signal processing into a single mechanism, as described in PCT Application Serial No. PCT/US02/22294. In still another aspect of the invention, the third component comprises software designed to decrease the noise and increase the resolution of the spectrum.

Using these three components, in addition to the existing XRF apparatus, allows easier and more efficient detection of low Z elements, especially in the field using a portable XRF apparatus. There are numerous substances, such as pharmaceuticals and food additives, which are comprised primarily of low Z elements. Detecting the element(s) or elemental constituent(s) in these substances has been difficult using a portable XRF device because of the abundance of such low Z elements. By using an XRF device containing the above 3 components, it has become easier and more feasible to analyze such substances.

In particular, pharmaceutical substances—either liquid, powder, or solid—can be analyzed much easier and quicker using a portable XRF device containing these 3 components. Indeed, a library of known pharmaceuticals can be created by obtaining the pharmaceuticals, analyzing them, and then placing their x-ray spectrum signature in the XRF device. Then, when analyzing an unknown pharmaceutical, its signature can be compared with the library to show the identity of the pharmaceutical. As new pharmaceutical products are discovered, their signatures can be obtained and added to the library.

The following non-limiting example illustrates the invention.

### EXAMPLE

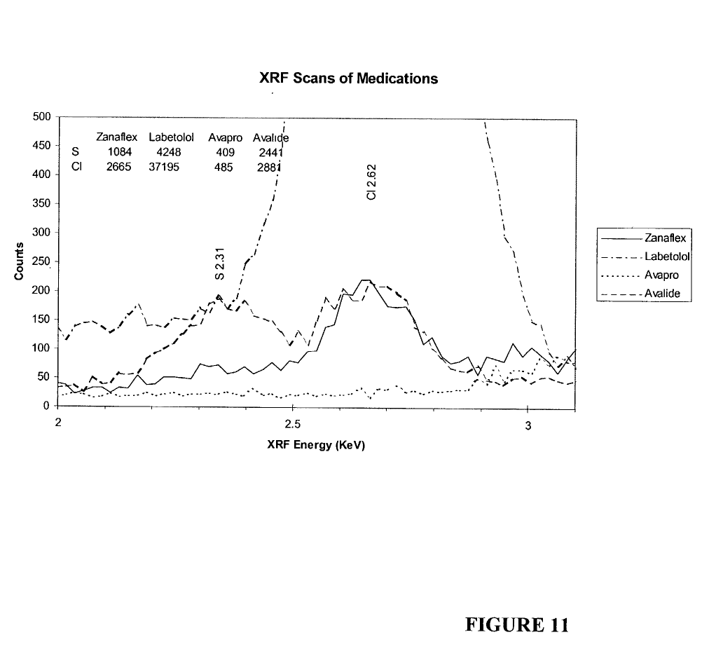

Four samples of known pharmaceuticals (Zanaflex, Labetolol, Avapro, and Avalide) in powder form were obtained. A hand-held XRF device similar to that depicted in U.S. Pat. No. D460,370 was made to contain an 15 mCi Fe55 x-ray source and a peltier-cooled silicon detector. The air at the front end of the XRF device was removed and then replaced with He. The XRF device was then used to analyze the four samples while in the He atmosphere. FIG. 11 depicts the resulting x-ray spectrum for the four samples.

Zanaflex is a centrally-acting alpha₂-adrenergic agonist containing the active ingredient Tizanidine HCl (5-chloro-4-(2-imidazolin-2-ylamino)-2, 1,3-benzothiodiazole hydrochloride; molecular formula of C₉H₈ClN₅S.HCl; molecular weight of 290.2) and the inactive ingredients, silicon dioxide colloidal, stearic acid, microcrystalline cellulose and anhydrous lactose. Sulfur and chlorine are clearly present in FIG. 10. Silicon should also be seen, but the system processor threshold was set at about 1.75 keV, and silicon's k alpha line is at 1.74 keV.

Trandate is an adrenergic receptor blocking agent with the active ingredient labetalol hydrochloride (a racemate of two diastereoisomeric pairs with name 2-hydroxy-5-[1-hydroxy-2-[(1-methyl-3 phenylpropyl)amino]ethyl]benzamide monohydrochloride; empirical formula of C₁₉H₂₄N₂O₃.HCl; molecular weight of 364.9) and the inactive ingredients corn starch, FD&C Yellow No. 6 (100- and 300- mg tablets only), hydroxypropyl methylcellulose, lactose, magnesium stearate, methylparaben, pregelatinized corn starch, propylparaben, sodium benzoate (200-mg tablet only), talc (100-mg tablet only) and titanium dioxide.

AVAPRO® is an angiotensin II receptor (AT 1 subtype) antagonist containing the active ingredient Irbesartan (2-butyl-3-[[29-(1H-tetrazol-5-yl) [1, 19-biphenyl]-4-yl]methyl]1,3-diazaspiro[4,4] non-1-en-4-one; empirical formula of C₂₅H₂₈N₆O; molecular weight of 428.5) and inactive ingredients including lactose, microcrystalline cellulose, pregelatinized starch, croscarmellose sodium, poloxamer 188, silicon dioxide and magnesium stearate.

Avalide contains the two active ingredients Irbesartan and HCTZ (Hydrochlorothiazide, the 3,4-dihydro derivative of chlorothiazide; chemical name of 6-chloro-3,4-dihydro-2H-1,2,4-benzothiadiazine-7-sulfonamide 1,1-dioxide; empirical formula of C₇H₈ClN₃O₄S₂; molecular weight of 297.72) and the inactive ingredients calcium phosphate, FD&C Yellow 6, gelatin, lactose, magnesium stearate, starch and talc.

Having described the preferred aspects of the invention, it is understood that the invention defined by the appended claims is not to be limited by particular details set forth in the above description, as many apparent variations thereof are possible without departing from the spirit or scope thereof.

We claim:

1. A method for detection, comprising:
providing an object containing an elemental constituent comprising a low atomic number element;
creating a substantially light gas atmosphere near the object;
causing the elemental constituent to radiate an x-ray through said atmosphere; and
detecting through said atmosphere whether the x-ray has a specific energy.

2. The method of claim 1, wherein the object is a manufactured good or a trade good.

3. The method of claim 2, wherein the object is a pharmaceutical product.

4. The method of claim 1, wherein the low atomic number element has an atomic number ranging from 6 to 17.

5. The method of claim 1, where the element is O, Mg, S, F, or Cl.

6. The method of claim 1, wherein the elemental constituent has a concentration less than about 100 ppm.

7. The method of claim 1, wherein the object comprises a plurality of elemental constituents with different concentrations.

8. The method of claim 1, wherein the light gas atmosphere comprises He.

9. The method of claim 3, including causing the elemental constituent to radiate an x-ray by impinging an x-ray from a portable x-ray fluorescence device on the elemental constituent.

10. The method of claim 9, wherein the portable x-ray fluorescence device comprises a library of information about pharmaceutical products.

11. A method for detection, comprising:
providing an object containing an elemental constituent;
creating a substantially light gas atmosphere near the object;
causing the elemental constituent to radiate an x-ray through said atmosphere by impinging an x-ray from an x-ray fluorescence device on the elemental constituent; and
detecting through said atmosphere whether the x-ray has a specific energy.

12. The method of claim 11, wherein the elemental constituent comprises an element with an atomic number ranging from 6 to 17.

13. The method of claim 11, wherein light gas atmosphere comprises He.

14. The method of claim 11, wherein the x-ray fluorescence device comprises a library of information about the object.

15. The method of claim 11, wherein the object is a pharmaceutical product and the x-ray fluorescence device is portable.

16. A method for analyzing an unknown pharmaceutical product, comprising:
obtaining an unknown pharmaceutical product;
creating a substantially light gas atmosphere near the pharmaceutical product;
impinging an x-ray from a x-ray fluorescence device on the elemental constituent, wherein the x-ray fluorescence device comprises a library of information about pharmaceutical product; and
detecting through said atmosphere whether the x-ray has a specific energy.

17. The method of claim 16, wherein the pharmaceutical product comprises an element with an atomic number ranging from 6 to 17.

18. The method of claim 17, where the element is O, Mg, S, F, or Cl.

19. The method of claim 17, wherein light gas atmosphere comprises He.

20. An attachment for a portable x-ray fluorescence device, the attachment comprising:
a chamber;
means for isolating the chamber from the ambient atmosphere;
means for creating a light gas atmosphere in the chamber; and
means for the chamber to communicate with a reservoir containing a light gas mixture.

21. The device of claim 20, wherein the portable device is a hand-held device.

22. The device of claim 20, wherein the communicating means comprises a line connecting the chamber and the reservoir.

23. The device of claim 20, wherein the isolating means comprises means for sealing the chamber to an object to be analyzed and means for restraining the chamber near the region of a detector in the x-ray fluorescence device.

24. The device of claim 23, further comprising sealing means between the chamber and the x-ray fluorescence device.

25. The device of claim 20, wherein the light gas atmosphere comprises He.

26. A portable x-ray fluorescence device, comprising:
an x-ray fluorescence device containing a source and a detector; and
an attachment containing:
a chamber;
means for isolating the chamber from the ambient atmosphere;
means for creating a light gas atmosphere in the chamber; and
means for the chamber to communicate with a reservoir containing a light gas mixture.

27. The device of claim 26, wherein the portable device is a hand-held device.

28. The device of claim 26, wherein the communicating means comprises a line connecting the chamber and the reservoir.

29. The device of claim 26, wherein the isolating means comprises means for sealing the chamber to an object to be analyzed and means for restraining the chamber near the region of a detector in the x-ray fluorescence device.

30. The device of claim 26, further comprising sealing means between the chamber and the x-ray fluorescence device.

31. The device of claim 26, wherein the light gas atmosphere comprises He.

32. The device of claim 26, wherein the source comprises an x-ray tube.

33. The device of claim 26, wherein the detector comprises a window designed to permit passage of low-energy x-rays therethrough.

34. The device of claim 26, wherein the x-ray device contains low-noise electronics.

35. The device of claim 34, wherein the low noise electronics comprise hardware combining both analog and digital signal processing in a single mechanism.

36. The device of claim 34, wherein the low noise electronics comprise software designed to increase the resolution of the of the x-ray spectrum produced by the detector.
